(19) United States
(12) Patent Application Publication
(10) Pub. No.: US 2026/0109294 A1
(43) Pub. Date: Apr. 23, 2026

(54) VEHICULAR EXTENDABLE AND RETRACTABLE EXTERIOR MIRROR

(71) Applicant: Magna Mirrors of America, Inc., Holland, MI (US)

(72) Inventor: Matthew V. Steffes, Grand Rapids, MI (US)

(21) Appl. No.: 19/362,641

(22) Filed: Oct. 20, 2025

Related U.S. Application Data
(60) Provisional application No. 63/710,908, filed on Oct. 23, 2024.

(51) Int. Cl. B60R 1/07; B60R 1/078

(52) U.S. Cl. CPC B60R 1/07; B60R 1/078

(57) ABSTRACT

A vehicular exterior rearview mirror assembly includes a mounting structure configured to mount the mirror assembly at a side of a vehicle and that includes an arcuate rail. A mirror head accommodates a mirror reflective element and is movable relative to the mounting structure between a retracted position and an extended position. Engagement between an arcuate guide element attached at the mirror head and the arcuate rail guides movement of the mirror head along an arcuate path between the retracted and extended positions. An adjustment mechanism is operable to move the mirror head between the retracted and extended positions and includes a drive gear disposed at the mounting structure and a drive track attached at the mirror head and engaging the drive gear. When an actuator is electrically operated, rotation of the drive gear imparts translational movement of the drive track to move the mirror head.

### CROSS REFERENCE TO RELATED APPLICATION

The present application claims the filing benefits of U.S. provisional application Ser. No. 63/710,908, filed Oct. 23, 2024, which is hereby incorporated herein by reference in its entirety.

### FIELD OF THE INVENTION

The present invention relates generally to the field of exterior rearview mirror assemblies for vehicles and, more particularly, to extendable and retractable exterior rearview mirror assemblies for vehicles.

### BACKGROUND OF THE INVENTION

It is known to provide an automotive exterior rearview mirror assembly that may be extended and retracted, such as for trailer towing applications, where the mirror assembly may be extended to provide enhanced rearward viewing to the driver of the trailer pulling vehicle. Examples of extendable and retractable mirror assemblies are described in U.S. Pat. Nos. 5,483,385; 6,116,743; 6,213,609; 6,239,928; 6,276,808; 6,325,518; 6,394,616 and/or 6,497,491, which are hereby incorporated herein by reference in their entireties.

### SUMMARY OF THE INVENTION

An exterior rearview mirror assembly includes a mounting structure configured to mount the vehicular exterior rearview mirror assembly at a side of a vehicle, and a mirror head accommodating a mirror reflective element. The mounting structure includes an arcuate rail. With the vehicular exterior rearview mirror assembly mounted at the side of the vehicle, the mirror head is movable relative to the mounting structure between (i) a retracted position where the mirror head is positioned at the side of the vehicle so that the mirror reflective element provides a rearward view to a driver of the vehicle that is at least rearward and along the side of the vehicle and (ii) an extended position where the mirror head is extended from the retracted position outward from the side of the vehicle to provide the rearward view to the driver of the vehicle. The mirror head is closer to the side of the vehicle at which the mounting structure is attached when in the retracted position as compared to the extended position. An arcuate guide element is attached at the mirror head and engages the arcuate rail of the mounting structure. Engagement between the arcuate guide element and the arcuate rail guides movement of the mirror head along an arcuate path between the retracted position and the extended position. An adjustment mechanism is operable to move the mirror head relative to the mounting structure between the retracted position and the extended position. The adjustment mechanism includes a drive gear disposed at the mounting structure and a drive track attached at the mirror head and engaging the drive gear. The adjustment mechanism includes an actuator that is electrically operable to rotatably drive the drive gear. When the actuator electrically operates to rotatably drive the drive gear, rotation of the drive gear imparts translational movement of the drive track to move the mirror head along the arcuate path between the retracted position and the extended position.

These and other objects, advantages, purposes and features of the present invention will become apparent upon review of the following specification in conjunction with the drawings.

### BRIEF DESCRIPTION OF THE DRAWINGS

FIG. 1 is a perspective view of an exterior rearview mirror assembly mounted at the side of a vehicle;

FIG. 2A is a schematic diagram showing an example field of view of a driver viewing the mirror reflective element of the exterior rearview mirror assembly with the mirror head in a retracted state;

FIG. 2B is a schematic diagram showing an example field of view of a driver viewing the mirror reflective element of the exterior rearview mirror assembly with the mirror head in an extended state;

FIGS. 3 and 4 are plan views of a mounting arm of the exterior rearview mirror assembly;

FIG. 5 is a perspective view of the mounting arm with a carrier attached at arcuate rails of the mounting arm for moving the mirror head along an arcuate path between the retracted state and the extended state;

FIG. 6 is a perspective view of an upper engagement element of the carrier;

FIG. 7 is an enlarged view of a drive gear of the actuator engaging a drive track of the upper engagement element; and

FIG. 8 is a schematic view of the mounting arm and the carrier, showing the arcuate path of the mirror head between the retracted state and the extended state.

### DESCRIPTION OF THE PREFERRED EMBODIMENTS

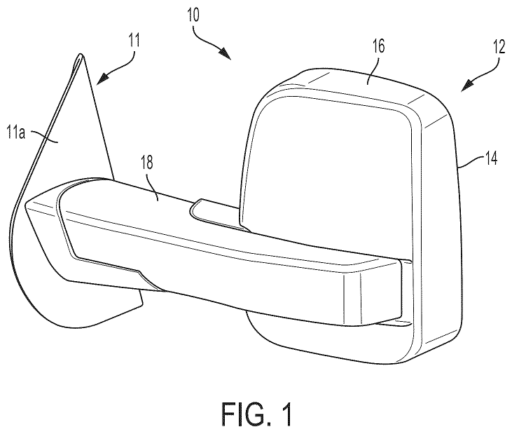

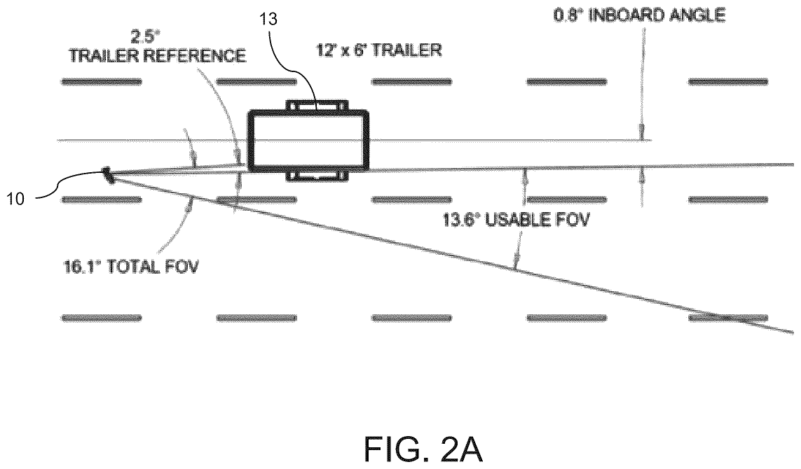

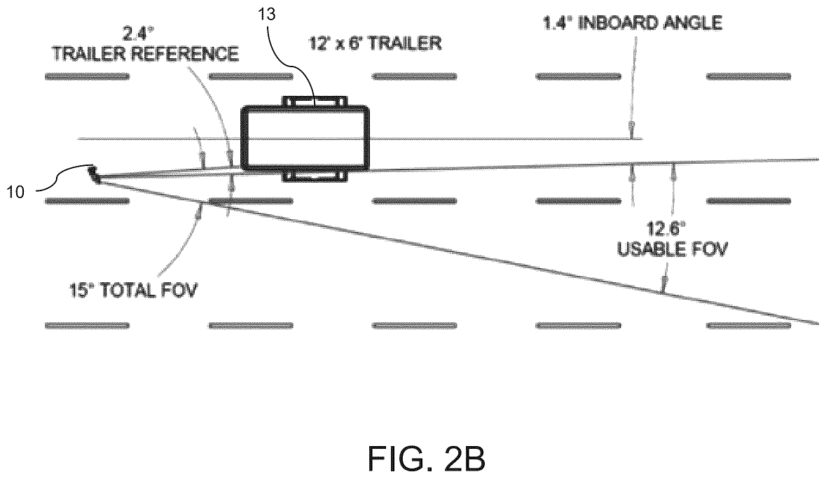

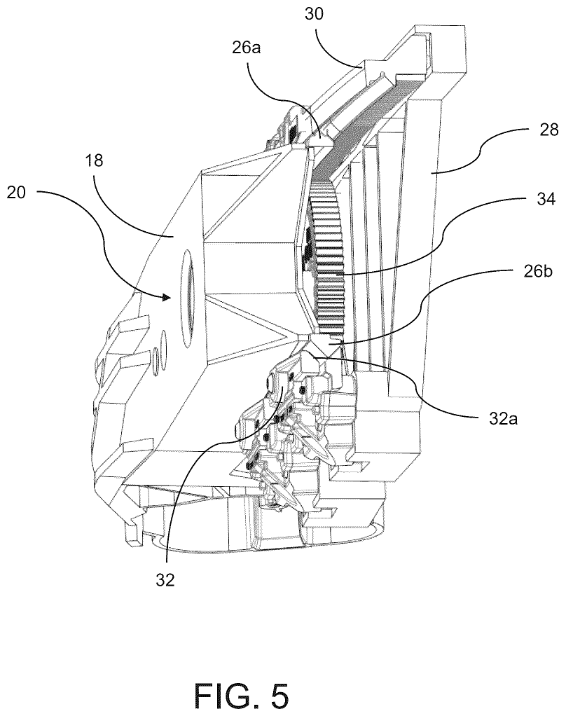

Referring now to the drawings and the illustrative embodiments depicted therein, an exterior rearview mirror assembly 10 for a vehicle 11 includes a mirror head 12 having a mirror reflective element 14 received in and/or supported at or by a mirror shell or casing 16 (FIG. 1). The mirror head 12 may be adjustably mounted at a mounting structure or arm 18 at a side 11a of the vehicle 11 and adjustable via an adjustment mechanism or device or electrically operable actuator 20 (FIG. 5) that adjusts the mirror head between a retracted state and an extended state. For example, the adjustment mechanism 20 may be housed within the mirror head 12 and thus move together and in tandem with the mirror head between the retracted state and the extended state, or the adjustment mechanism 20 may be mounted at the mounting arm 18 for moving the mirror head 12 relative to the adjustment mechanism 20. The mounting arm 18 of the mirror assembly 10 is mounted at the side 11a of the host or subject vehicle 11, with the reflective element 14 providing a rearward field of view along the respective side of the vehicle to the driver of the vehicle. ; When the mirror head 12 is in the retracted state, the mirror reflective element 14 provides a first rearward field of view along the side 11a of the vehicle 11 (FIG. 2A) and, when the mirror head 12 is in the extended state, the mirror head 12 is moved from the retracted state further outboard of the side 11a of the vehicle 11 to provide a second rearward field of view along the side 11a of the vehicle 11 (FIG. 2B), such as a wider field of view that extends further outward from the side 11a of the vehicle 11 than the first field of view. That is, because the mirror head 12 is disposed further outboard from the side 11a of the vehicle 11 in the extended state as compared to the retracted state, the second field of view may originate from or provide a vantage point from a wider position outboard of the side of the vehicle. The mirror head 12 may be tilted at least slightly inward toward the side of the vehicle when moved from the retracted state to the extended state, such that a primary viewing axis extending perpendicular to the plane of the mirror reflective element 14 may be disposed at a greater angle relative to a longitudinal axis of the vehicle 11 with the mirror head 12 in the extended state as compared to the retracted state. The mirror head 12 may be movable between the retracted state and the extended state responsive to a user input within the vehicle and actuatable by the driver of the vehicle.

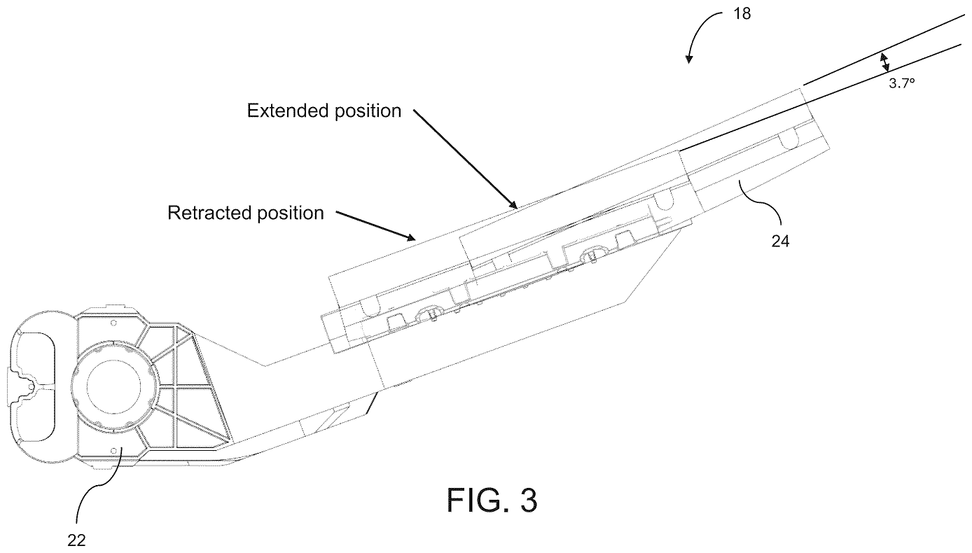

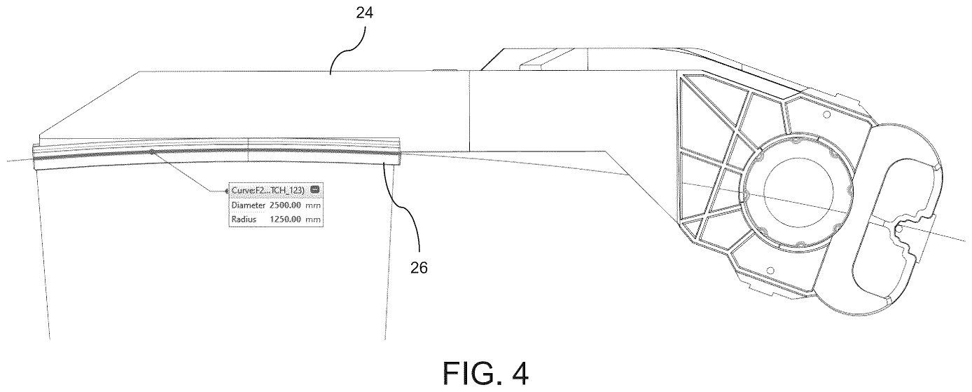

Referring to FIGS. 3 and 4, the mounting arm 18 includes a base portion 22 that mounts at the side 11a of the vehicle 11 and a guide or track portion 24 extending from the base portion 22 to support the mirror head 12 outboard of the side of the vehicle. The mounting arm or structure 18 may enable power folding and/or manual pivoting of the mirror head 12 relative to the side of the vehicle, such that the mirror head 12 may be pivotable between a folded or park position, where the mirror head 12 is disposed along the side of the vehicle so that the mirror reflective element 14 faces the side of the vehicle, and a deployed or use position, where the mirror head 12 is pivoted out from the side of the vehicle so that the mirror reflective element 14 provides the field of view rearward and along the side of the vehicle to the driver. For example, the track 24 may be pivotable relative to the base portion 22 to move the mirror head 12 between the folded position and the deployed position, or the base portion 22 or a part of the base portion 22 may be pivotable relative to the side of the vehicle to move the mirror head 12 between the folded position and the deployed position. With the mounting arm 18 extended from the side of the vehicle (i.e., when the mirror head is in the deployed position), the mirror head is adjustable between the retracted state and the extended state via operation of the adjustment mechanism 20 to move the mirror head 12 along the track 24. The track portion 24 of the mounting arm 18 includes a set of arcuate guides or rail portions 26 that curve relative to the track portion 24. The mirror head 12 rides along the set of rails 26 to change the angle of the mirror head 12 relative to the longitudinal axis of the vehicle as the mirror head 12 is moved between the retracted state and the extended state. For example, with the mirror head 12 in the retracted state, the primary viewing axis extending perpendicular to the mirror reflective element 14 may be disposed at an angle relative to the longitudinal axis of the vehicle 11 of about 0.8 degrees (FIG. 2A). With the mirror head 12 in the extended state, the primary viewing axis may be disposed at an angle relative to the longitudinal axis of the vehicle 11 of about 1.4 degrees (FIG. 2B). This may allow the driver to view a greater portion of a region rearward of the vehicle 11 (i.e., in a same road lane of travel as the equipped vehicle 11), such as to at least partially view a region rearward of the vehicle 11 and rearward of a trailer 13 hitched to the vehicle 11.

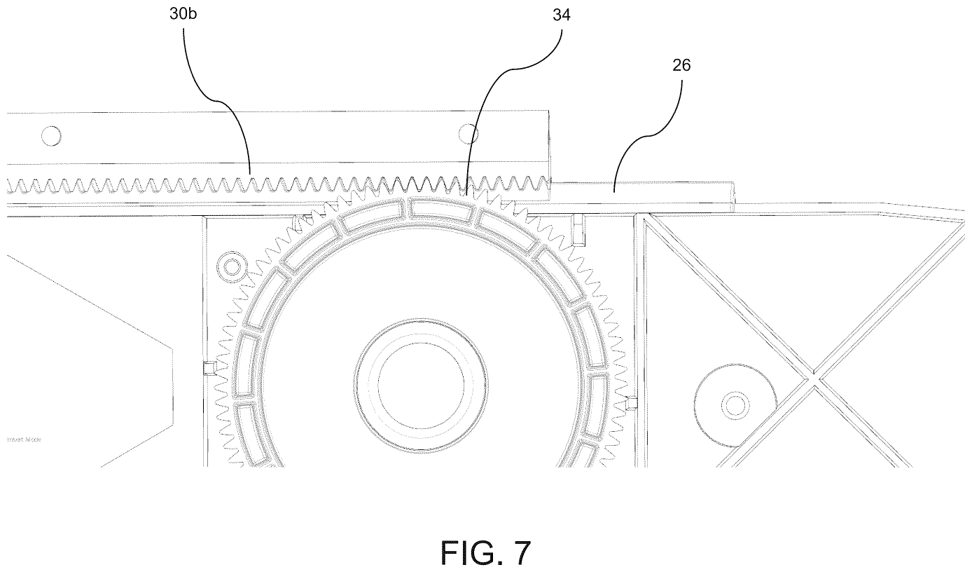

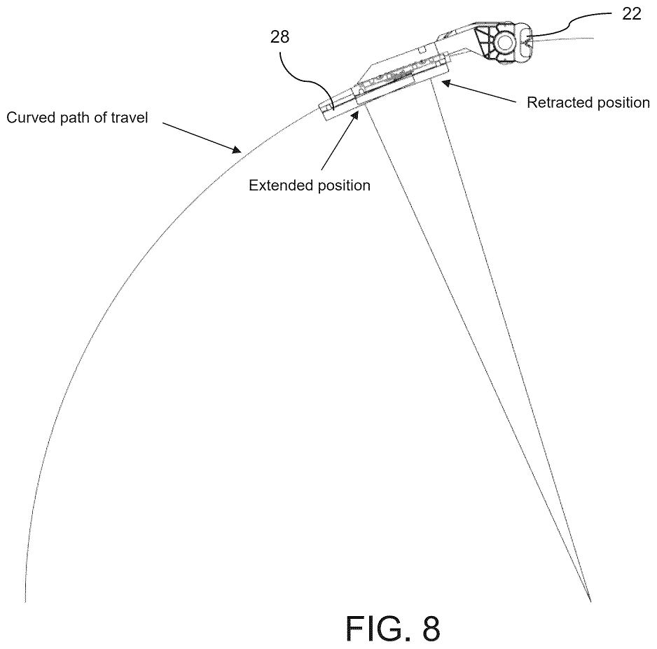

As shown in FIGS. 5-8, the track portion 24 of the mounting arm 18 includes an upper arcuate rail 26a disposed at an upper portion or surface of the mounting arm 18 and a lower arcuate rail 26b at a lower portion or surface of the mounting arm 18 and the mirror head 12 may be attached to or include a carrier 28 that is movably disposed along the rails 26 of the track portion 24. For example, a portion of the mirror casing or a mirror bracket accommodated by the mirror head 12 may be attached to the carrier 28 and the carrier 28 engages the rails 26 to guide movement of the carrier 28 and mirror head 12 along the arcuate path of the rails 26.

The carrier 28 includes an upper engagement member 30 having an upper arcuate sliding pad or guide element 30a and an arcuate drive rack 30b, and the carrier 28 includes a lower engagement member 32 having a lower arcuate sliding pad or guide element 32a. The upper sliding pad 30a engages and rides along the upper rail 26a and the lower sliding pad 32a engages and rides along the lower rail 26b. The upper sliding pad 30a and the lower sliding pad 32a include channels that have respective contours or shapes that correspond to respective contours or shapes of the upper rail 26a and the lower rail 26b to encourage smooth and precise movement of the mirror head 12 along the arcuate path of the rails 26. In the illustrated example, the upper rail 26a has a cross section with an upward facing triangular shape and the lower rail 26b has a cross section with a downward facing triangular shape. The channel of the upper sliding pad 30a and the channel of the lower sliding pad 32a may have corresponding triangular cross sections with notches or recesses at the respective vertexes of the triangular channels for promoting airflow and preventing sticking of the sliding pads relative to the rails 26. That is, the upper rail 26a may not extend within the notch of the upper sliding pad 30a and the lower rail 26b may not extend within the notch of the lower sliding pad 32a to preclude an interference fit from forming between the rails 26a, 26b and the sliding pads 30a, 32a. Moreover, the sliding pads and the rails may be formed from any suitable material, such as an injection molded thermoplastic having a low coefficient of friction to promote movement of the mirror head along the rails. Optionally, a lubricant such as a liquid or gel may be disposed between the sliding pads and the rails to allow for slidable movement of the sliding pads relative to the rails.

The actuator 20 may be disposed at the mounting arm 18 and includes a drive gear 34 that engages teeth of the drive rack 30b and, when the actuator 20 (e.g., an electrically operable motor of the actuator) is electrically operated, the drive gear 34 is driven to cause translational movement of the carrier 28 and the mirror head 12 along the rails 26. In other words, the drive gear 34 and the drive rack 30b form a rack and pinion style relationship to move the carrier 28 and the mirror head 12 when the actuator 20 is operated. The motor of the actuator 20 may be disposed at the mounting arm 18, such as for driving the drive gear 34 via a gear train between the motor and the drive gear 34. Optionally, the motor may be spaced from the drive gear 34, such as at the mounting base or side of the vehicle, and drive the drive gear 34 via a belt or chain or other intermediate drive element.

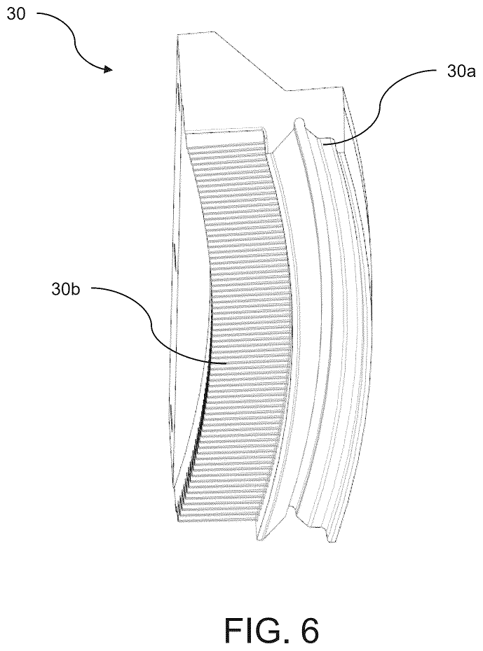

The mating components of the mirror head 12 to the rails 26 (e.g., the upper sliding pad 30a, the drive rack 30b and the lower sliding pad 32a) may be curved about the same central axis as the curved rails 26. In other words, the upper engagement member 30 and the lower engagement member 32 may have a curved or arcuate shape that corresponds to the curved or arcuate shape of the rails 26 (FIG. 6). For example, the curve of the rails 26 (and thus the upper engagement member 30 and the lower engagement member 32) may have a radius of curvature of about 1.25 meters (FIG. 4).

Thus, when the mirror head 12 is in the retracted position, the mirror head 12 and the carrier 28 may be disposed at a first end region of the mounting arm 18 nearest the side of the vehicle and when the mirror head 12 is moved to the extended position, the mirror head 12 and the carrier 28 are moved along the rails 26 toward a second end region of the mounting arm 18 opposite the first end region and spaced further from the side of the vehicle than the first end region (FIG. 3). The curvature of the rails 26 may cause the plane of the mirror reflective element 14 to be angled more toward the side 11a of the vehicle 11 at the extended position than at the retracted position, such as a 3.7 degree angle change of the plane of the mirror reflective element 14 relative to the longitudinal axis of the vehicle 11 between the extended position and the retracted position. This may cause the field of view at the mirror reflective element 14 to pivot or shift relative to the vehicle and trailer. For example, with the mirror head 12 in the retracted position with a 0.8 degree inboard angle of the principal viewing axis of the mirror reflective element 14 relative to the longitudinal axis of the vehicle 11, the total field of view provided by the mirror reflective element 14 may be about 16.1 degrees wide with about 13.6 degrees of the field of view providing a usable view of the road sideward and at least partially rearward of the trailer 13 and about 2.5 degrees of the field of view providing a reference view of the trailer 13 (FIG. 2A). With the mirror head 12 in the extended position with a 1.4 degree inboard angle of the principal viewing axis of the mirror reflective element 14 relative to the longitudinal axis of the vehicle 11, the total field of view provided by the mirror reflective element 14 may be about 15 degrees wide with about 12.6 degrees of the field of view providing a usable view of the road sideward and at least partially rearward of the trailer 13 and about 2.4 degrees of the field of view providing a reference view of the trailer 13 (FIG. 2B).

Moreover, the actuator 20, rails 26 and carrier 28 may be utilized with a dual arm or twin arm extendable and retractable mirror assembly, where the mirror head is supported at the side of the vehicle via an upper mounting arm and a lower mounting arm that extend parallel to one another from the side of the vehicle. The mirror head moves along both mounting arms when moved between the retracted position and the extended position. The carrier may engage both of the mounting arms, such that the upper mounting arm may include the upper rail and the lower mounting arm may include the lower rail. Optionally, both the upper mounting arm and the lower mounting arm may include respective sets of upper and lower rails with the carrier moving along both sets of upper and lower rails. The actuator may include an electrically operable motor and a drive gear disposed at the upper mounting arm driving the drive rack of the upper engagement member at the upper rail for moving the carrier along both the upper mounting arm and the lower mounting arm. In some examples, the electrically operable motor of the actuator may drive a gear train including gears engaging respective drive racks at the upper mounting arm and the lower mounting arm for simultaneously driving the respective drive racks to move the carrier along both the upper mounting arm and the lower mounting arm. Optionally, the actuator may include respective motors and drive gears at the upper mounting arm and the lower mounting arm for simultaneously driving respective drive racks at the upper rail and lower rail to move the carrier along both the upper mounting arm and the lower mounting arm.

Optionally, the actuator 20 may include a clutch or slip mechanism to enable manual movement of the mirror head 12 along the mounting arm 18 between the retracted position and the extended position. For example, the clutch may be disposed between the electrically operable motor and the drive gear 34. When the motor is electrically operated to drive the drive gear 34, the clutch is engaged to transfer motion from the motor through the clutch element to the drive gear 34. When a force is experienced at the mirror head (e.g., due to a user manually moving the mirror head), the clutch slips and the drive gear 34 moves relative to the motor as the carrier 28 and the mirror head 12 move along the mounting arm 18. Further, the clutch may prevent damage to the motor when the actuator 20 is operated and the mirror head 12 is prevented from moving along the mounting arm 18 (such as due to ice buildup or an obstacle preventing movement). That is, when the motor is operated and a force prevents the mirror head 12 from moving along the mounting arm 18, the motor may slip relative to the drive gear 34.

Thus, trailer outside mirrors may be extended outward from the vehicle (either electrically or manually) to improve the rearward field of view around a trailer. Typically, the glass must be adjusted by the user after changing from the retracted to the extended position and vice versa. Glass adjustment is typically necessary because changing the position of the reflective surface further from or closer to the vehicle without re-aiming the mirror glass will result in a less than ideal rearward field of view. A 4-bar linkage extend mechanism may be used to auto-adjust the entire extending mirror head during extend and retract action, eliminating the need for the user to manually adjust the mirror glass after extending or retracting the trailer tow mirror. Additionally, a sliding mechanism may be used to auto-adjust the entire extending mirror head during extend and retract action, by providing an arc path (rather than straight) to adjust the mirror aim between retracted and extended positions.

The mirror assembly includes an extend mechanism in which the mirror head rides on the set of rails (integrated into the mirror arm bracket) which are curved to change the angle of the mirror head relative to the central plane of the vehicle. The mating components to the rail features (e.g., the upper and lower sliding pads and drive rack) are curved about the same central axis as the curved rails. This may be applied both to single-arm and twin-arm styles of extending trailer-towing mirrors. The change in rearward field of view as a result of changing the head angle and position from retracted to extended allow more useable vision behind the trailer.

The extendable and retractable mirror assembly may utilize characteristics of the mirror assemblies described in U.S. Pat. Nos. 11,845,383 and/or 11,718,232, and/or U.S. Publication Nos. US-2025-0222867; US-2023-0012333 and/or US-2023-0373392, and/or U.S. patent application Ser. No. 19/207,700, filed May 14, 2025 (Attorney Docket DON09 P5376), which are hereby incorporated herein by reference in their entireties.

Changes and modifications in the specifically described embodiments may be carried out without departing from the principles of the present invention, which is intended to be limited only by the scope of the appended claims as interpreted according to the principles of patent law.

1. A vehicular exterior rearview mirror assembly, the vehicular exterior rearview mirror assembly comprising:
a mounting structure configured to mount the vehicular exterior rearview mirror assembly at a side of a vehicle, wherein the mounting structure comprises an arcuate rail;
a mirror head accommodating a mirror reflective element;
wherein, with the vehicular exterior rearview mirror assembly mounted at the side of the vehicle, the mirror head is movable relative to the mounting structure between (i) a retracted position where the mirror head is positioned at the side of the vehicle so that the mirror reflective element provides a rearward view to a driver of the vehicle that is at least rearward and along the side of the vehicle and (ii) an extended position where the mirror head is extended from the retracted position outward from the side of the vehicle to provide the rearward view to the driver of the vehicle;
wherein the mirror head is closer to the side of the vehicle at which the mounting structure is attached when the mirror head is in the retracted position as compared to when the mirror head is in the extended position;
wherein an arcuate guide element is attached at the mirror head and engages the arcuate rail of the mounting structure, and wherein engagement between the arcuate guide element and the arcuate rail guides movement of the mirror head along an arcuate path between the retracted position and the extended position;
an adjustment mechanism that, with the vehicular exterior rearview mirror assembly mounted at the side of the vehicle, is operable to move the mirror head relative to the mounting structure between the retracted position and the extended position;
wherein the adjustment mechanism comprises (i) a drive gear disposed at the mounting structure and (ii) a drive rack attached at the mirror head and engaging the drive gear;
wherein the adjustment mechanism comprises an actuator that is electrically operable to rotatably drive the drive gear; and
wherein, with the vehicular exterior rearview mirror assembly mounted at the side of the vehicle, and when the actuator electrically operates to rotatably drive the drive gear, rotation of the drive gear imparts translational movement of the drive rack to move the mirror head along the arcuate path between the retracted position and the extended position.

2. The vehicular exterior rearview mirror assembly of claim 1, wherein the arcuate rail comprises (i) an upper arcuate rail of an upper portion of the mounting structure and (ii) a lower arcuate rail of a lower portion of the mounting structure.

3. The vehicular exterior rearview mirror assembly of claim 2, wherein the arcuate guide element comprises (i) an upper arcuate guide element attached at the mirror head and engaging the upper arcuate rail and (ii) a lower arcuate guide attached at the mirror head and engaging the lower arcuate rail.

4. The vehicular exterior rearview mirror assembly of claim 1, wherein the arcuate rail and the arcuate guide element comprise a common radius of curvature.

5. The vehicular exterior rearview mirror assembly of claim 4, wherein the drive rack comprises the common radius of curvature.

6. The vehicular exterior rearview mirror assembly of claim 1, wherein the arcuate guide element comprises a channel, and wherein the arcuate rail rides within and engages the channel as the mirror head moves along the arcuate path between the retracted position and the extended position.

7. The vehicular exterior rearview mirror assembly of claim 6, wherein a cross-sectional shape of the arcuate rail corresponds to a cross-sectional contour of the channel.

8. The vehicular exterior rearview mirror assembly of claim 1, wherein, with the mirror head at the retracted position, a primary viewing axis of the mirror reflective element extending normal to a plane of the mirror reflective element is disposed at a first angle relative to a longitudinal axis of the vehicle, and wherein, with the mirror head at the extended position, the primary viewing axis of the mirror reflective element is disposed at a second angle relative to the longitudinal axis of the vehicle, and wherein the second angle is greater than the first angle.

9. The vehicular exterior rearview mirror assembly of claim 1, wherein the adjustment mechanism is operable to adjust the mirror head relative to the mounting structure in response to a user input disposed in the vehicle, and wherein the user input is actuatable by the driver of the vehicle.

10. A vehicular exterior rearview mirror assembly, the vehicular exterior rearview mirror assembly comprising:
a mounting structure configured to mount the vehicular exterior rearview mirror assembly at a side of a vehicle, wherein the mounting structure comprises an arcuate rail;
a mirror head accommodating a mirror reflective element;
wherein, with the vehicular exterior rearview mirror assembly mounted at the side of the vehicle, the mirror head is movable relative to the mounting structure between (i) a retracted position where the mirror head is positioned at the side of the vehicle so that the mirror reflective element provides a rearward view to a driver of the vehicle that is at least rearward and along the side of the vehicle and (ii) an extended position where the mirror head is extended from the retracted position outward from the side of the vehicle to provide the rearward view to the driver of the vehicle;
wherein the mirror head is closer to the side of the vehicle at which the mounting structure is attached when the mirror head is in the retracted position as compared to when the mirror head is in the extended position;
wherein, with the mirror head at the retracted position, a primary viewing axis of the mirror reflective element extending normal to a plane of the mirror reflective element is disposed at a first angle relative to a longitudinal axis of the vehicle, and wherein, with the mirror head at the extended position, the primary viewing axis of the mirror reflective element is disposed at a second angle relative to the longitudinal axis of the vehicle, and wherein the second angle is greater than the first angle;
wherein an arcuate guide element is attached at the mirror head and engages the arcuate rail of the mounting structure, and wherein engagement between the arcuate guide element and the arcuate rail guides movement of the mirror head along an arcuate path between the retracted position and the extended position;
an adjustment mechanism that, with the vehicular exterior rearview mirror assembly mounted at the side of the vehicle, is operable to move the mirror head relative to the mounting structure between the retracted position and the extended position;
wherein the adjustment mechanism comprises (i) a drive gear disposed at the mounting structure and (ii) a drive rack attached at the mirror head and engaging the drive gear;
wherein the arcuate rail, the arcuate guide element and the drive rack comprise a common radius of curvature;
wherein the adjustment mechanism comprises an actuator that is electrically operable to rotatably drive the drive gear; and
wherein, with the vehicular exterior rearview mirror assembly mounted at the side of the vehicle, and when the actuator electrically operates to rotatably drive the drive gear, rotation of the drive gear imparts translational movement of the drive rack to move the mirror head along the arcuate path between the retracted position and the extended position.

11. The vehicular exterior rearview mirror assembly of claim 10, wherein the arcuate rail comprises (i) an upper arcuate rail of an upper portion of the mounting structure and (ii) a lower arcuate rail of a lower portion of the mounting structure, and wherein the arcuate guide element comprises (i) an upper arcuate guide element attached at the mirror head and engaging the upper arcuate rail and (ii) a lower arcuate guide attached at the mirror head and engaging the lower arcuate rail.

12. The vehicular exterior rearview mirror assembly of claim 10, wherein the arcuate guide element comprises a channel, and wherein the arcuate rail rides within and engages the channel as the mirror head moves along the arcuate path between the retracted position and the extended position.

13. The vehicular exterior rearview mirror assembly of claim 12, wherein a cross-sectional shape of the arcuate rail corresponds to a cross-sectional contour of the channel.

14. The vehicular exterior rearview mirror assembly of claim 10, wherein the adjustment mechanism is operable to adjust the mirror head relative to the mounting structure in response to a user input disposed in the vehicle, and wherein the user input is actuatable by the driver of the vehicle.

15. A vehicular exterior rearview mirror assembly, the vehicular exterior rearview mirror assembly comprising:
a mounting structure configured to mount the vehicular exterior rearview mirror assembly at a side of a vehicle, wherein the mounting structure comprises an arcuate rail;
a mirror head accommodating a mirror reflective element;
wherein, with the vehicular exterior rearview mirror assembly mounted at the side of the vehicle, the mirror head is movable relative to the mounting structure between (i) a retracted position where the mirror head is positioned at the side of the vehicle so that the mirror reflective element provides a rearward view to a driver of the vehicle that is at least rearward and along the side of the vehicle and (ii) an extended position where the mirror head is extended from the retracted position outward from the side of the vehicle to provide the rearward view to the driver of the vehicle;
wherein the mirror head is closer to the side of the vehicle at which the mounting structure is attached when the mirror head is in the retracted position as compared to when the mirror head is in the extended position;
wherein an arcuate guide element is attached at the mirror head and engages the arcuate rail of the mounting structure, and wherein engagement between the arcuate guide element and the arcuate rail guides movement of the mirror head along an arcuate path between the retracted position and the extended position;
wherein the arcuate rail comprises (i) an upper arcuate rail of an upper portion of the mounting structure and (ii) a lower arcuate rail of a lower portion of the mounting structure;
wherein the arcuate guide element comprises (i) an upper arcuate guide element attached at the mirror head and engaging the upper arcuate rail and (ii) a lower arcuate guide attached at the mirror head and engaging the lower arcuate rail;
an adjustment mechanism that, with the vehicular exterior rearview mirror assembly mounted at the side of the vehicle, is operable to move the mirror head relative to the mounting structure between the retracted position and the extended position;
wherein the adjustment mechanism comprises (i) a drive gear disposed at the mounting structure and (ii) a drive rack attached at the mirror head and engaging the drive gear;
wherein the adjustment mechanism comprises an actuator that is electrically operable to rotatably drive the drive gear;
wherein, with the vehicular exterior rearview mirror assembly mounted at the side of the vehicle, and when the actuator electrically operates to rotatably drive the drive gear, rotation of the drive gear imparts translational movement of the drive rack to move the mirror head along the arcuate path between the retracted position and the extended position; and
wherein the adjustment mechanism is operable to adjust the mirror head relative to the mounting structure in response to a user input disposed in the vehicle, and wherein the user input is actuatable by the driver of the vehicle.

16. The vehicular exterior rearview mirror assembly of claim 15, wherein the arcuate rail and the arcuate guide element comprise a common radius of curvature.

17. The vehicular exterior rearview mirror assembly of claim 16, wherein the drive rack comprises the common radius of curvature.

18. The vehicular exterior rearview mirror assembly of claim 15, wherein the arcuate guide element comprises a channel, and wherein the arcuate rail rides within and engages the channel as the mirror head moves along the arcuate path between the retracted position and the extended position.

19. The vehicular exterior rearview mirror assembly of claim 18, wherein a cross-sectional shape of the arcuate rail corresponds to a cross-sectional contour of the channel.

20. The vehicular exterior rearview mirror assembly of claim 15, wherein, with the mirror head at the retracted position, a primary viewing axis of the mirror reflective element extending normal to a plane of the mirror reflective element is disposed at a first angle relative to a longitudinal axis of the vehicle, and wherein, with the mirror head at the extended position, the primary viewing axis of the mirror reflective element is disposed at a second angle relative to the longitudinal axis of the vehicle, and wherein the second angle is greater than the first angle.
